(19) United States
(12) Patent Application Publication
(10) Pub. No.: US 2008/0162535 A1
(43) Pub. Date: Jul. 3, 2008

(54) System for administering insurance

(76) Inventor: Jeff Bak, Tampa, FL (US)

Correspondence Address: HARNESS, DICKEY & PIERCE, P.L.C., P.O. BOX 828, BLOOMFIELD HILLS, MI, 48303, US

(21) Appl. No.: 11/647,515

(22) Filed: Dec. 28, 2006

(51) Int. Cl. G06F 17/30

(52) U.S. Cl. 707/102

(57) ABSTRACT

A hierarchical data structure is provided for administering insurance products for customers associated with different groups. The data structure includes: a group level having a data record for each group of insurance customers; a customer level having a data record for each insurance customer, where each data record has a child relationship to one of the data records in the group level; and a policy level having a data record for each of the insurance policies held by an insurance customer, where each data record includes an identifier for the insurer whom issued the insurance policy and has a child relationship to one of the data records in the customer level, such that insurance customers within a group can have insurance policies from different insurance insurers.

### FIELD

The present disclosure relates to a system and method for administering insurance.

### BACKGROUND

Gone are the days of one-size-fits-all health plans. Businesses and individual consumers have hundreds of plans to choose from, ranging from HMOs and traditional medical plans to complex managed care arrangements. What is lacking is a robust system for administering insurance that provides efficient risk management, billing, enrollment and eligibility, case administration, commission payment, rating, agent licensing and cash reconciliation. The system should make it easy to integrate and access information by providing a single platform with standardized reporting, including rating engine for billing, rates and renewals. The present invention integrates all lines of coverage into one seamless system. Employers receive one monthly bill that sums the total amount due for multiple lines of coverage, along with a separate report detailing the amount to deduct from each employee's paycheck for a payroll cycle

The statements in this section merely provide background information related to the present disclosure and may not constitute prior art.

### SUMMARY

In one aspect of the disclosure, a hierarchical data structure is provided for administering insurance products for customers associated with different groups. The data structure includes: a group level having a data record for each group of insurance customers; a customer level having a data record for each insurance customer, where each data record has a child relationship to one of the data records in the group level; and a policy level having a data record for each of the insurance policies held by an insurance customer, where each data record includes an identifier for the insurer whom issued the insurance policy and has a child relationship to one of the data records in the customer level, such that insurance customers within a group can have insurance policies from different insurance insurers.

In another aspect of this disclosure, a method is provided for allocating insurance premium payments amongst multiple insurance policies held by an insurance customer. The method includes: receiving a premium payment from an insurance customer; comparing the premium payment to an aggregate amount due for the insurance policies held by the insurance customer; and allocating the premium payment to different insurance policies in accordance with an allocation rule.

Further areas of applicability will become apparent from the description provided herein. It should be understood that the description and specific examples are intended for purposes of illustration only and are not intended to limit the scope of the present disclosure.

### DRAWINGS

FIG. 1 is a diagram of an exemplary hierarchical data structure for administering insurance;

FIG. 2 is a block diagram of a portion of a software-implemented system for administering insurance products;

FIG. 3 illustrates an exemplary bill which may be generated by the system;

FIG. 4 is a flowchart depicting an exemplary method for allocating insurance premium payments amongst multiple insurance policies held by an insurance customer; and

FIGS. 5A-5F illustrates the user interfaces of the system which enables customers to direct which insurance policies are to be paid.

The drawings described herein are for illustration purposes only and are not intended to limit the scope of the present disclosure in any way.

### DETAILED DESCRIPTION

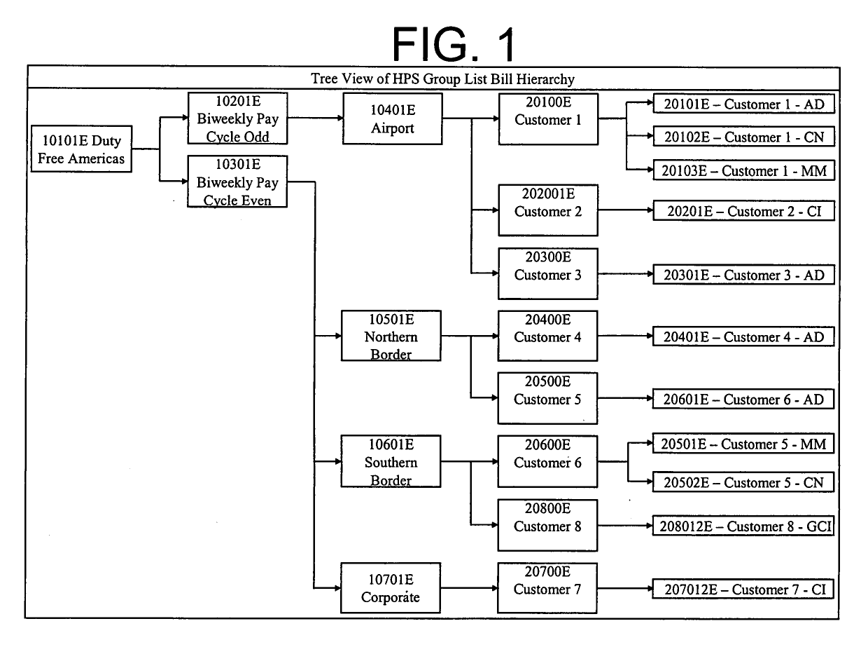

FIG. 1 illustrates an exemplary hierarchical data structure 10 for administering insurance products for customers associated with different groups. In a simplified form, the hierarchical data structure includes at least a group level, a customer level and a policy level. In another exemplary form, the hierarchical data structure may include a group level, a billing level, one or more reporting levels, a customer level and a policy level. Each level is organized in a tree structure so that each record in a given level has a pointer to its parent record in the level above. Each of these different levels is further described below. However, other hierarchical levels may be incorporated into the data structure. While the following description is provided with reference to a hierarchical data structure, it is understood that the broader aspects of this disclosure pertain to other types of data structures (e.g., relational).

The group level includes a data record for each group of insurance customers. For instance, an employer is a group that provides insurance coverage to its employees. Each data record for a group will include a unique group identifier, a group name and contact information, such as contact person, business address, phone number, etc., for the group.

Since most groups are large entities having different locations, it is desirable to have more than one billing location associated with a group. Each bill record defines the attributes for a billing location associated with a given group. For example, a billing record may include a unique record identifier, a pointer to a data record in the group level, contact information, such as contact person, business address, phone number etc., for the billing location, and an identifier for the billing schedule for the billing location.

Similarly, a billing location may have different groups of people which have different reporting requirements. Each reporting record defines different reporting groups at the billing location. For example, more than one business unit may reside at a billing location. In this example, there might be a reporting record for each business unit. Other types of reporting groups may include different classes of employees (e.g., union vs. non-union), different divisions, different department within a division, and different cost centers. An exemplary data record in the reporting level may include a unique record identifier, a pointer to a data record in the billing level and a grouping attribute. As will be further described below, different business rules may be applied to the different reporting groups at a given billing location.

The customer level includes a data record for each person within a given group. Each data record will in turn define the pertinent attributes associated with the person. For example, a customer record may include a name, address, phone number, birth date, sex, social security number, date hired by employer, etc. In a simple form, the person associated with the data record is the insured. The customer record may also include information regarding the dependents of the insured person. Alternatively, this information may reside at an intermediate dependents level disposed between the customer level and the coverage level. As with the other data records, the customer record will include a unique record identifier and a pointer to a data record in the level above.

Lastly, a coverage level defines each of the insurance policies held by an insured person. For example, an insured person may have a coverage record for a medical policy, another coverage record for a dental policy, and a third coverage record for life insurance policy. Each coverage record defines the attributes associated with the policy. Some exemplary attributes include policy type, policy effective date, information regarding the insurance provider (or carrier) as well as information regarding the agent whom sold or is responsible for the policy. The coverage record also includes a unique record identifier and a pointer to a data record in the customer level. Supporting different insurance carriers for a given person or a group of persons employed by the same employer is one of the unique aspects of this disclosure.

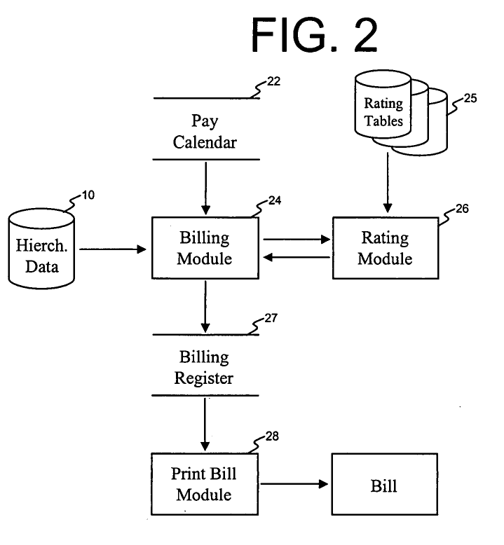

FIG. 2 depicts a portion of a software-implemented system for administering insurance products. Of interest, is how the system generates a single bill that aggregates deduction amounts across multiple insurance policies from different insurance carriers. Briefly, the billing subsystem 20 is comprised of a pay calendar 22, a billing module 24, a rating module 26, a bill print module 28 and the hierarchical data structure 10 described above. The process for generating a bill is further described below. It is to be understood that only the relevant steps of the billing cycle are discussed below, but that other software-implemented instructions may be needed to control and manage the overall operation of the system.

To begin a billing cycle, the billing module 24 first reads a pay calendar 22. The pay calendar generally provides a schedule for when bills are to be generated for a group and when the deductions are to be taken from persons belonging to the group. For example, an employer who pays their employees on a bi-weekly basis may opt to have a bi-weekly deduction period for their employees but opts only to receive a bill on a monthly basis. In an exemplary embodiment, the pay calendar may define a deduction cycle, a deduction taken date, a billing cycle, and designated delivery dates. The delivery dates specify the date a bill is to be generated by the system depending on the type of delivery method. For instance, a delivery date for paper bill must take into account the time it takes for a courier (e.g., government mail service or private courier) to delivery the bill to the recipient. In contrast, a delivery date for a bill that is sent by electronic mail may be generated on the day (or the day before) it is to be delivered to the recipient. When a new customer is entered into the system, the customer is linked to an entry in the pay calendar. More specifically, each billing location for a customer is linked by a billing schedule identifier in the billing location level of the hierarchical data structure. It is understood that different customers may share the same pay calendar or each customer may specify their own unique pay calendar.

On a daily basis, the billing module determines what bills need to be generated by reading the pay calendar. When an entry in the pay calendar has a delivery date that matches the current date, the entry requires further processing by the billing module. In particular, the billing module searches for all billing locations which use the identified pay calendar and require the specified delivery method. For each matching billing location, the billing module will generate a bill as further described below.

To generate a bill for a given billing location, the billing module traverses the hierarchical data structure to determine each insured person associated with the billing location and then determines each coverage associated with a given person. The list of persons and coverages is then passed on to a rating module for further processing.

A plurality of rating tables is made available to the rating module. For instance, each different insurance carrier provides one or more rating tables for each of the different insurance products supported by the system. Rating tables specify premiums in a standard increment (e.g., monthly premiums) in a manner which is known in the art. However, because each coverage record specifies the insurance carrier as well as the type of coverage, the system is able to support different tables from different insurance carriers. The rating module is able to access the appropriate table to determine the monthly premium for each coverage. Given a list of persons and coverages, the rating module aggregates each entry in the list with a corresponding monthly premium for the coverage. It is readily understood that a monthly premium is recomputed each time a bill is generated to account for any changes with the insured (e.g., added or removed a dependent, moved to a new location, etc.).

The aggregated list of persons, coverages and monthly premiums is then returned to the billing module. From the monthly premium, the billing module then computes a modal premium for each coverage, where the modal premium correlates to the deduction period requested by the customer. For example, if the premiums are being deducted on a bi-weekly basis, a monthly premium is multiplied by twelve (12) and then divided by twenty-six (26) to determine a bi-weekly premium. In addition, the billing module determines how many deduction cycles occurred during the current billing cycle and thus how many times a person was charged during the current billing cycle. The billing module records each deduction as a deduction record in a data store referred to herein as a billing register. As a result, the billing module has computed one or more deduction records for each coverage held by each person at the given billing location.

Next, the billing module aggregates the individual deduction records. For each insured person, their individual deduction records are aggregated at a carrier level. If an individual has coverage from only one insurance provider, then the total deduction amount for the individual is recorded in a single record. If the individual has coverage from more than one insurance provider, then a total deduction amount for each different carrier is recorded in a different record. Each of the different carrier level records for an individual are then summed to form another record which aggregates the total deduction amounts from all of the different carriers. This process is repeated for each person at the billing location. Each of these data records are also stored in the billing register.

When there are no intermediate reporting levels for the billing location, the aggregate record for each person at the billing location is summed to get a total bill amount for the billing location. To the extent there are intermediary reporting levels, an aggregate record is first created for each intermediate reporting level by summing the deduction amounts for each person in the reporting level prior to creating an aggregate record for the entire billing location. It is readily understood that deduction amounts can be rolled up in accordance with however many reporting levels are defined in the hierarchical data structure. In this way, a detailed electronic bill has been compiled for the billing location. This electronic bill is preferably made available online for viewing by customer representatives.

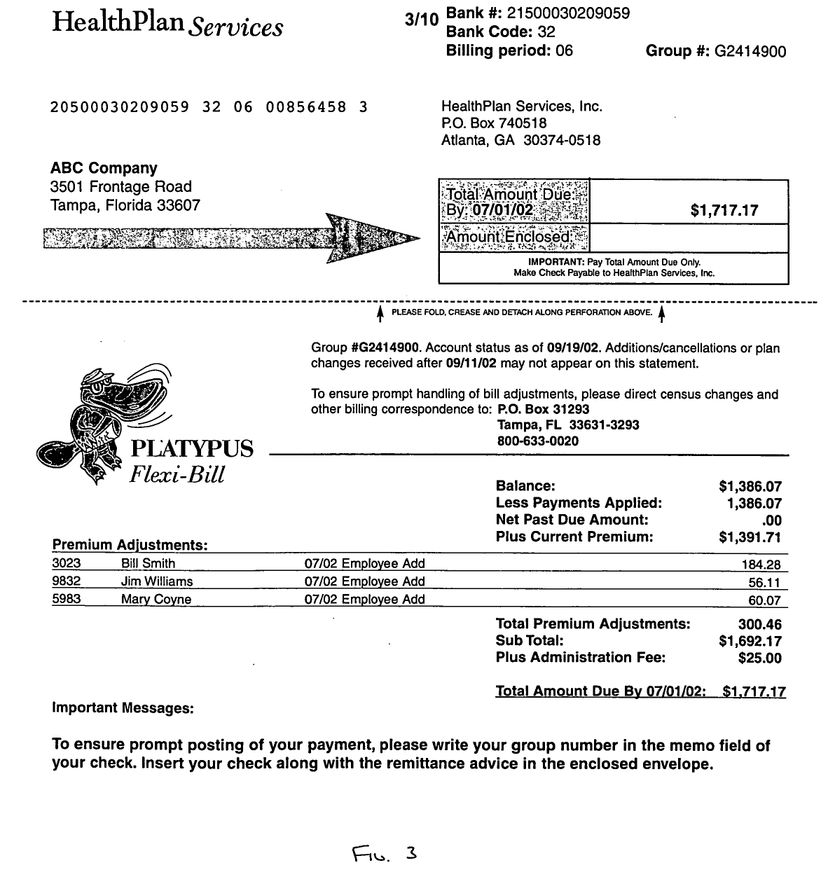

Lastly, the electronic bill serves as the basis for the bill which is provided to the customer. A print bill module accesses the billing register to generate a customer's bill. For a hardcopy of the bill, the print bill module formulates a suitable print request and sends it to an appropriate printing device. For a bill sent by email, the print bill module formulates an electronic message and sends the message to the customer. It is readily understood that the customer bill may or may not contain detail deduction information for each person at the billing location. Rather, the customer bill preferably provides summary data regarding the amount due. Exemplary bills are shown in FIGS. 3A and 3B.

In addition to generating customer bills, the system is designed to receive and process payment of bills. Each night received payments are processed. In particular, payments are posted to the group identified on the bill. The payments are then allocated down to the policy level using data in the billing register. Payments are further allocated to the specific coverage periods within a policy. Payments are applied to the oldest open amount first. Once all payments have been allocated, the system calculates the latest period each insurance policy is paid through. This paid thru date may be used to adjudicate claims and/or reported to the insurance carrier.

When less than full payment is received, the system is designed to allocate the payment amongst the different insurance policies. Given the robustness of the system to support different types policies issued by different carriers, a rule set for allocating premiums amongst these polices may be required. In the past, such allocation rules would not have been needed.

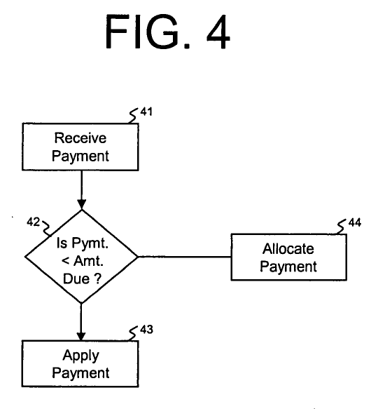

Exemplary methods for allocating insurance premium payments are further described in relation to FIG. 4. In all instance, a premium payment received from an insurance customer is compared at 42 to the aggregate amount due for the insurance customer. When the payment received is less than the amount due, the payment is allocated 44 to different insurance policies in accordance with an allocation rule. It is understood that the allocation rules are defined by and agreed upon by system administrator, the insurance customers, the insurance carriers or combinations thereof. Exemplary allocation rules are further described below.

In one exemplary embodiment, payments may be allocated based on the type of insurance policy. For example, the allocation rule may specify that life insurance policies are to be paid before medical insurance policies which are in turn to be paid before dental insurance policies. Assume an insured has paid $80, but the amount owed by the insured is $100. More specifically, assume that the insured owes $15 for life insurance, $80 for medical insurance and $5 for dental insurance. In this instance, the life insurance policy would be paid in full with the remainder applied to the medical insurance. It is noteworthy that the allocation is made independent of who the insurance carrier is for each policy.

In another exemplary embodiment, payments may be allocated proportionally across the insurance policies. Continuing with the example above, $12 would be applied to life insurance, $64 would be applied to medical insurance and $4 would be applied to dental insurance.

In yet another exemplary embodiment, payment may be allocated based on whom the insurance carrier is associated with each insurance policy. For example, the allocation rule may specify that Carrier A's policies are to be paid before Carrier B's policies. It is also envisioned that these types of rules may be combined to define to a more complex rule set. For example, an allocation rule set may specify that Carrier A's policies are to be paid before Carrier B's policies. Each insurance carrier may further define how payments are to be allocated amongst policies issued by the carrier based on the type of insurance policy as described above. It is understood that other types of allocation rules may be defined.

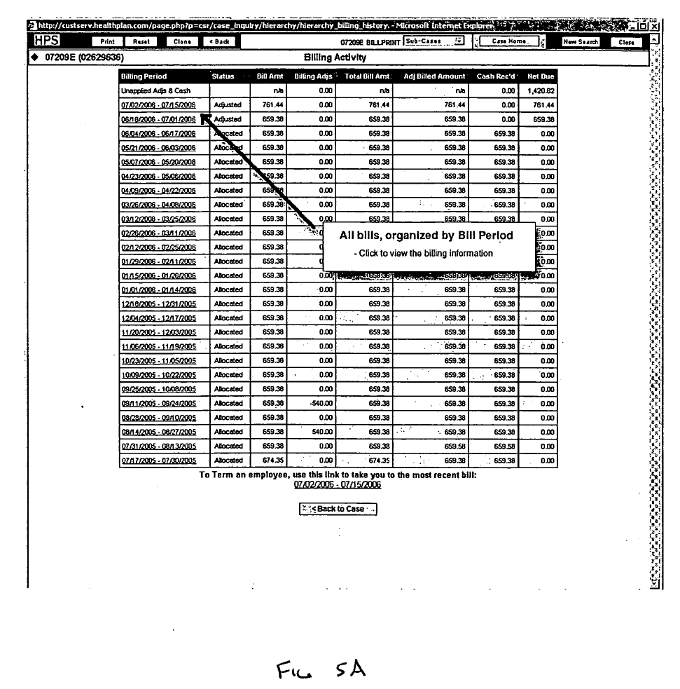

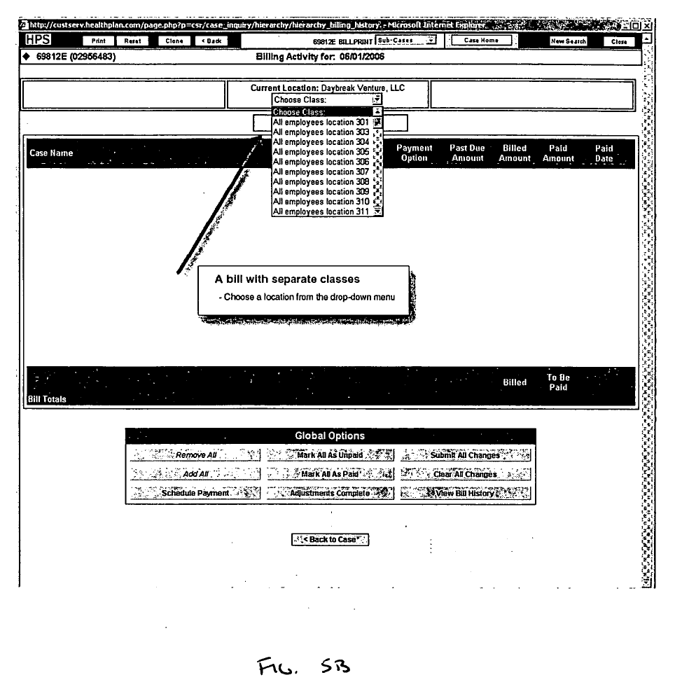

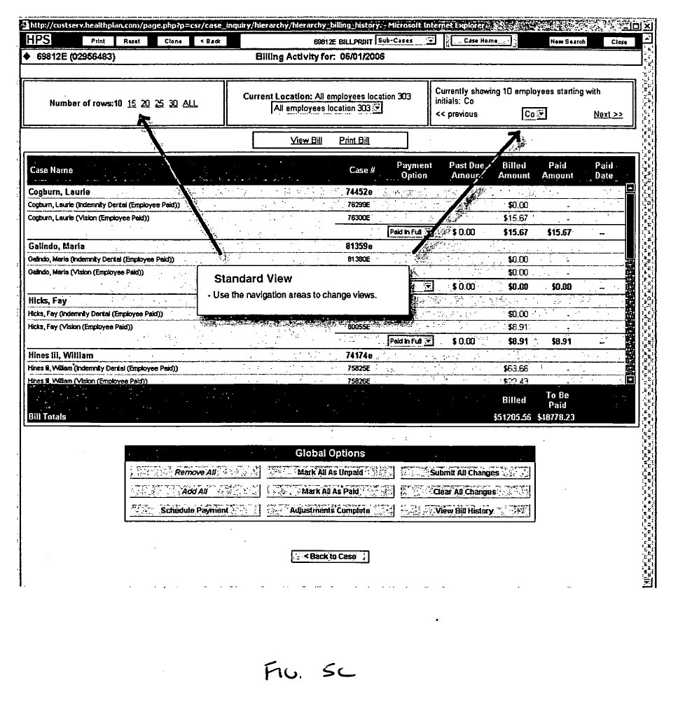

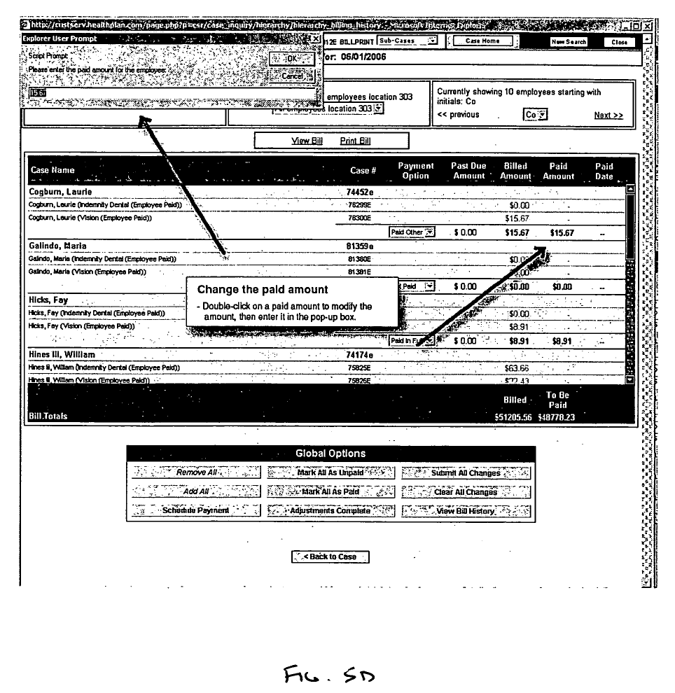

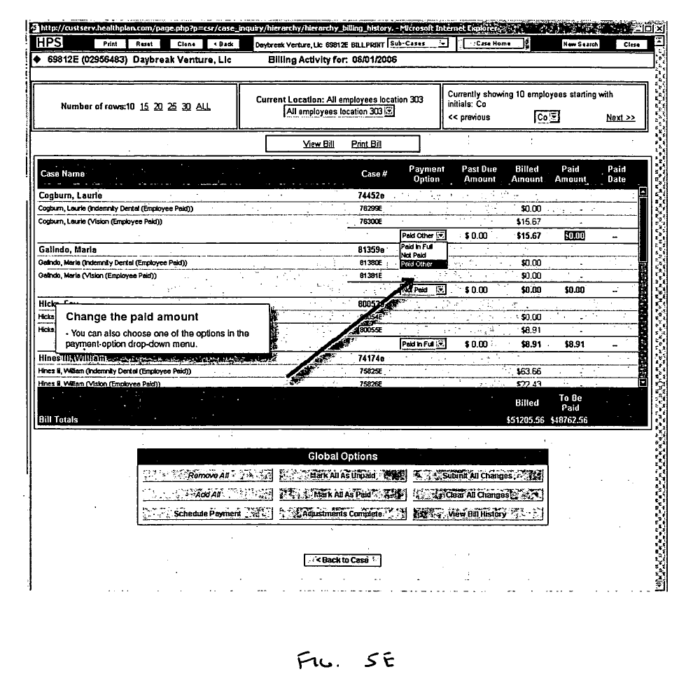

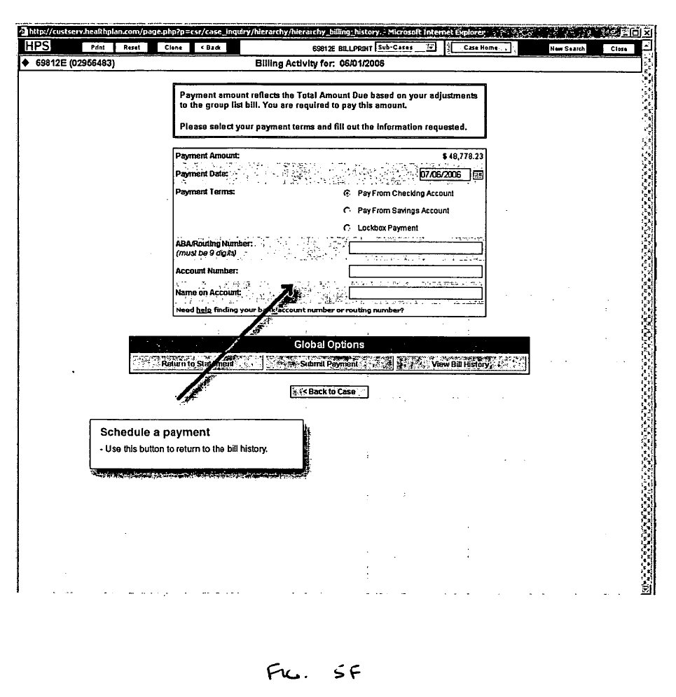

The system also provides an interface which enables customers to direct which insurance policies are to be paid. To adjust a bill, the first sep is to choose the bill period one would like to work with. This is done on the billing history view, where all the bills are organized by there bill period as shown in FIG. 5A. After choosing the bill period to work with, the billing aggregator will load. If the bill has multiple classes or locations, those will be displayed in the navigation area as indicated in FIG. 5B. The location or class may be chosen. Once the information loads, the customer is able to continue navigating by using various tools in the navigation area. For example, one can choose the number of records you would like to display per page or jump to the page with the first two letter of the last name as shown in FIG. 5C.

In the billing aggregator view, one can easily see the various coverages for each individual on a bill as well as the billed and paid amounts. To change the amount a customer pay for an individual, the amount is selected. A pop-window will allow the customer to enter the new amount as shown in FIG. 5D. Alternatively, one can use a drop-down menu under the payment options header as shown in FIG. 5E. If “Paid in Full” is chosen, the system will set the paid amount equal to the billed amount. If “Not Paid” is chosen, the system will set the paid amount to zero. If “Paid Other” is chosen, a pop-window is displayed where a new amount may be entered by the customer.

Once a customer is complete, it is necessary to save the changes. Once all changes have been made, the customer may want to schedule a payment. This can be done through the schedule payment view as shown in FIG. 5F. On the schedule payment view, the required information is entered and submitted. Once this has been done, the bill history can be reviewed using the bill history view. In this way, the system enables a customer to directed payments to particular insurance policies.

The following description is merely exemplary in nature and is not intended to limit the present disclosure, application, or uses.

What is claimed is:

1. A hierarchical data structure for administering insurance products for customers associated with different groups, comprising:
a group level having a data record for each group of insurance customers;
a customer level having a data record for each insurance customer, where each data record has a child relationship to one of the data records in the group level; and
a policy level having a data record for each of the insurance policies held by an insurance customer, where each data record includes an identifier for the insurer whom issued the insurance policy and has a child relationship to one of the data records in the customer level, such that insurance customers within a group can have insurance policies from different insurance insurers.

2. The hierarchical data structure for claim 1 wherein each data record in the group level includes a group identifier, a group name and contact information for the group.

3. The hierarchical data structure of claim 1 wherein each data record in the customer level includes information pertaining to the insurance customer.

4. The hierarchical data structure of claim 1 wherein each data record in the policy level further includes an indicator for the type of insurance policy, an effective date for the insurance policy and an identifier as to an agent who issued the policy to the customer.

5. The hierarchical data structure of claim 1 further comprises a billing level interposed between the group level and the customer level and having a data record for each billing location associated with a group, such that each data record has a child relationship to one of the data records in the group level.

6. The hierarchical data structure of claim 5 wherein each data record in the billing level includes an indicator for a billing schedule.

7. The hierarchical data structure of claim 1 further comprises a reporting level interposed between the group level and the customer level and having data records for different reporting groups within a group, where each data record has a child relationship to one of data records in the group level.

8. A hierarchical data structure for administering insurance products for customers associated with different groups, comprising:
a group level having a data record for each group of insurance customers;
a billing level having a data record for each billing location associated with a group, where each data record has a child relationship to one of the data records in the group level;
a reporting level having data records for different reporting groups residing at a billing location, where each data record has a child relationship to one of data records in the billing level;
a customer level having a data record for each insurance customer, where each data record has a child relationship to one of the data records in the reporting level; and
a policy level having a data record for each of the insurance policies held by an insurance customer, where each data record includes an identifier for the insurer whom issued the insurance policy and has a child relationship to one of the data records in the customer level, such that different insurance customers within a group can have different insurance policies from different insurance insurers.

9. The hierarchical data structure of claim 8 wherein each data record in the billing level includes an indicator for a billing schedule.

10. A system for administering insurance products for customers associated with different groups, comprising:
a pay calendar data store for storing schedules for when bills are to be generated;
a hierachical data structure for storing insurance information for a plurality of insurance customers, where the plurality of insurance customers are organized into groups and each group is linked to a schedule in the pay calendar; and
a billing module operable traverse the pay calendar data store and generate a bill for a given group of insurance customers based on the billing schedule for the given group.

11. The system of claim 10 wherein the hierachical data structure further comprises
a group level having a data record for each group of insurance customers;
a billing level having a data record for each billing location associated with a group, where each data record has a child relationship to one of the data records in the group level;
a customer level having a data record for each insurance customer, where each data record has a child relationship to one of the data records in the billing level; and
a policy level having a data record for each of the insurance policies held by an insurance customer, where each data record includes an identifier for the insurer whom issued the insurance policy and has a child relationship to one of the data records in the customer level, such that different insurance customers within a group can have different insurance policies from different insurance insurers.

12. The system of claim 11 wherein each billing location of a group is linked to a schedule in the pay calendar.

13. The system of claim 11 wherein the billing module traverses the customer level of the hierarchical data structure to determine each insurance customer associated with a given group and

14. The system of claim 13 wherein the billing module traverses the policy level of the hierarchical data structure for each insurance customer to determine each insurance policy issued to a given insurance customer.

15. The system of claim 14 wherein the billing module computes a premium due for each insurance policy for each insurance customer during a current billing cycle and aggregates computed premiums due to generate a bill.

16. A method for allocating insurance premium payments amongst multiple insurance policies held by an insurance customer, comprising:
receiving a premium payment from an insurance customer;
comparing the premium payment to an aggregate amount due for the insurance policies held by the insurance customer; and
allocating the premium payment to different insurance policies in accordance with an allocation rule, where the allocation rule allocates the premium payment based on the type of insurance policy.

17. The method of claim 1 wherein allocating the premium payment further comprises allocating premium payment to a life insurance policy before other types of insurance polices held by an insured.

18. A method for allocating insurance premium payments amongst multiple insurance policies held by an insurance customer, comprising:
receiving a premium payment from an insurance customer;
comparing the premium payment to an aggregate amount due for the insurance policies held by the insurance customer; and
allocating the premium payment to different insurance policies in accordance with an allocation rule, where the allocation rule allocates the premium payment based on an insurer associate with each of the insurance policies.
